(19) United States
(12) Patent Application Publication
(10) Pub. No.: US 2006/0039359 A1
(43) Pub. Date: Feb. 23, 2006

(54) Managed mobile voice over internet protocol (VoIP) overlay method and architecture

(76) Inventor: Joseph Wai-Ming Pang, Los Altos, CA (US)

Correspondence Address: Maryam Imam, Esq.;LAW OFFICES OF IMAM, Suite 1010, 111 North Market Street, San Jose, CA, 95113, US

(21) Appl. No.: 11/207,111

(22) Filed: Aug. 17, 2005

Related U.S. Application Data
(60) Provisional application No. 60/602,580, filed on Aug. 18, 2004.

(51) Int. Cl. H04L 12/66

(52) U.S. Cl. 370/352

(57) ABSTRACT

A managed mobile voice over internet protocol (VoIP) overlay network for use by public carriers for managing the connectivity and transport of media over the Internet is disclosed in accordance with an embodiment and method of the present invention.

### CROSS REFERENCE TO RELATED APPLICATIONS

This application claims priority to my pending and prior U.S. provisional patent application no. 60/602,580, filed on Aug. 18, 2004 and entitled “MANAGED MOBILE VOICE OVER INTERNET PROTOCOL (VoIP) OVERLAY METHOD AND ARCHITECTURE”, which is incorporated herein by reference as though set forth in full.

### BACKGROUND OF THE INVENTION

1. Field of the Invention

This invention relates generally to the field of voice over internet protocol (VoIP) and more particularly, to a managed mobile VoIP overlay architecture and method for use by public carriers.

2. Description of the Prior Art

Public carriers are facing the competitive pressure of peer-to-peer Voice over Internet Protocol (VoIP) services, both in terms of price and features. Although the carriers have made considerable effort to include VoIP technology into their future product and service strategy, they are apprehensive about the technological challenges and widespread acceptance of VoIP over the current public switched telephony network (PSTN) infrastructure and the future of Voice over Internet paradigm.

The traditional PSTN infrastructure is based on a highly organized and intelligent network, with fully managed and accountable services delivered to terminals with minimal intelligence (i.e., the telephone set). At the other extreme, VoIP is touted as a no-frill, non-provisioned and unmanaged network with services administered by highly intelligent terminals (i.e., the personal computer or other digital devices) and application servers. The differences are so fundamental between the two extremes that most public carriers have been reluctant to offer VoIP services to their customers.

Thus, the need arises to manage the connectivity and transport of media, such as audio over the Internet (or any other packet switching network) and to bridge the fundamental gap between the worlds of services such as PSTN and packet switched services (such as VoIP).

In light of the foregoing, it is desirable to develop a managed mobile VoIP overlay architecture and method for use by public carriers.

### SUMMARY OF THE INVENTION

Briefly, an embodiment of the present invention includes a managed mobile voice over internet protocol (VoIP) overlay network for use by public carriers for managing the connectivity and transport of media over the Internet. The network includes a distributed set of application service nodes deployed on top of the Internet and including a plurality of base stations and a plurality of VoIP terminals, located on the Internet, accessing the overlay network, one of the plurality of VoIP terminals latching onto one of the plurality of base stations, the selected base station onto which the VoIP terminal is latched being the ‘portal base station’, the latched VoIP terminal communicating only through the ‘portal base station’, to converse with another one of the plurality of VoIP terminals and for accessing backend services, the ‘portal base station’ being the sole entry point and communication proxy for the VoIP terminal 20 vis-à-vis the overlay network.

### IN THE DRAWINGS

FIG. 1 shows the architecture of an overlay network 10 in accordance with an embodiment of the present invention.

FIG. 2 depicts the multi-tier service architecture of the overlay network 10 of FIG. 1.

FIG. 3 shows a high-level and conceptual diagram of the connectivity of the overlay network 10 of FIG. 1 in accordance with an example embodiment of the present invention.

FIG. 4 shows FIG. 4 shows a flow chart of the steps performed when one of the VoIP terminals 20 of FIG. 1 selects a portal base station.

FIG. 5 shows a flow chart of the steps performed by a base station when it receives a request for service from a VoIP terminal.

### DETAILED DESCRIPTION OF THE PREFERRED EMBODIMENTS

A managed mobile VoIP overlay architecture for use by public carriers (referred to in this document as the “overlay architecture”) is described herein for managing the connectivity and transport of media such as audio over the Internet and to bridge the fundamental gap between the worlds of services such as PSTN and packet switched services such as VoIP. The new architecture is based on a fully managed VoIP (the public carrier determines who (or which user) can enter the overlay network or system switching network having application server nodes, called ‘base stations’ and ‘core switches’. This VoIP switching network can be overlaid on top of an existing Internet.

While the embodiments presented herein generally are in reference to audio VoIP terminals and the Internet, it should be recognized that the present invention applies equally well to other terminal types, to other media including video, messaging, and data over both public and private packet switched networks as well as to the management of the interconnection between networks such as between public carriers.

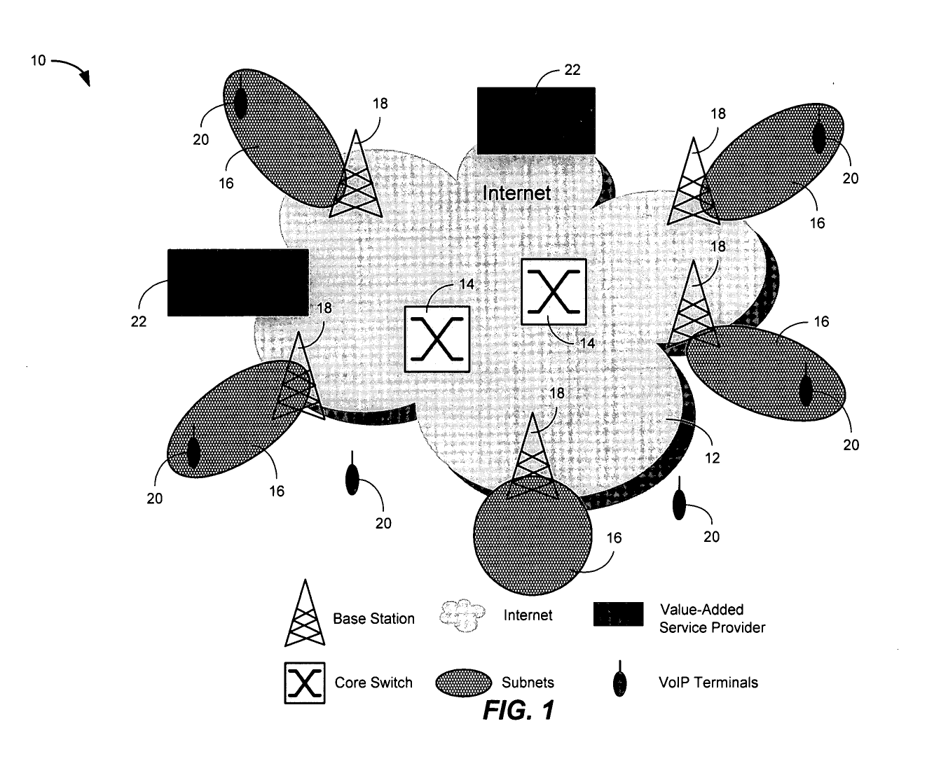

Referring now to FIG. 1, overlay architecture 10 is shown in accordance with an embodiment of the present invention. The overlay architecture 10 is shown to include an Internet (or packet switched network) 12 having core switches 14 throughout. Through the internet 12, various sub networks 16 (an example of a sub network is a corporate network) communicate, using base stations 18, to VoIP terminals 20. Such communication is generally managed by service providers 22 who essentially provide service through the Internet while charging a value for doing so.

In FIG. 1, the overlay architecture 10 includes a distributed set of application service nodes deployed on top of the Internet. These application service nodes are either base stations 18 or core switches 14. Although the base stations 18 can be logically deployed anywhere on the Internet, they are typically deployed at the boundary between private networks, such as the sub networks 16, and the Internet, most often at the ‘de-militarized zone’ of a firewall-protected corporate network, or at the data center of the carrier. Similarly, the core switches 14 can be deployed anywhere on the Internet, but they are typically deployed within the core infrastructure (e.g. central offices) of the carrier, where there are ample transmission bandwidth and carrier-grade security and protection.

The VoIP terminals 20 connect to the Internet 12 through the base stations 18 over Terminal-to-Overlay Interface (TOI). The base stations 18, in turn, connect o the core switches 14, which are located inside the Internet. The core switches 14 are again connected to other base stations, which are in turn connected to other VoIP terminals thereby completing a packet switching networking transfer of information. VoIP terminals 20 are always connected to base stations 18. The base stations 18 and the core switches 14 are distributed over the network therefore allowing for the overlay network 10 to exist.

Any one of the VoIP terminals 20, located anywhere on the Internet, can access the overlay network 10, by merely latching onto one of the many base stations 18; the selected base station 18 onto which the VoIP 20 is latched being called the ‘portal base station’. Once latched, the latched VoIP terminal 20 will only communicate through the ‘portal base station’, to converse with another VoIP terminal 20 and to access any backend services. Thus, the ‘portal base station’ is the sole entry point and communication proxy for the VoIP terminal 20 vis-à-vis the overlay network 10.

The communication path between the latched VoIP terminal 20 and the ‘portal base station’ can be a dial-up line, high-speed private network, virtual private link or any Internet connection. The communication protocol used between a VoIP terminal 20 and its ‘portal base station’ is called the TOI. TOI is based on the standard Session Initiation Protocol (SIP).

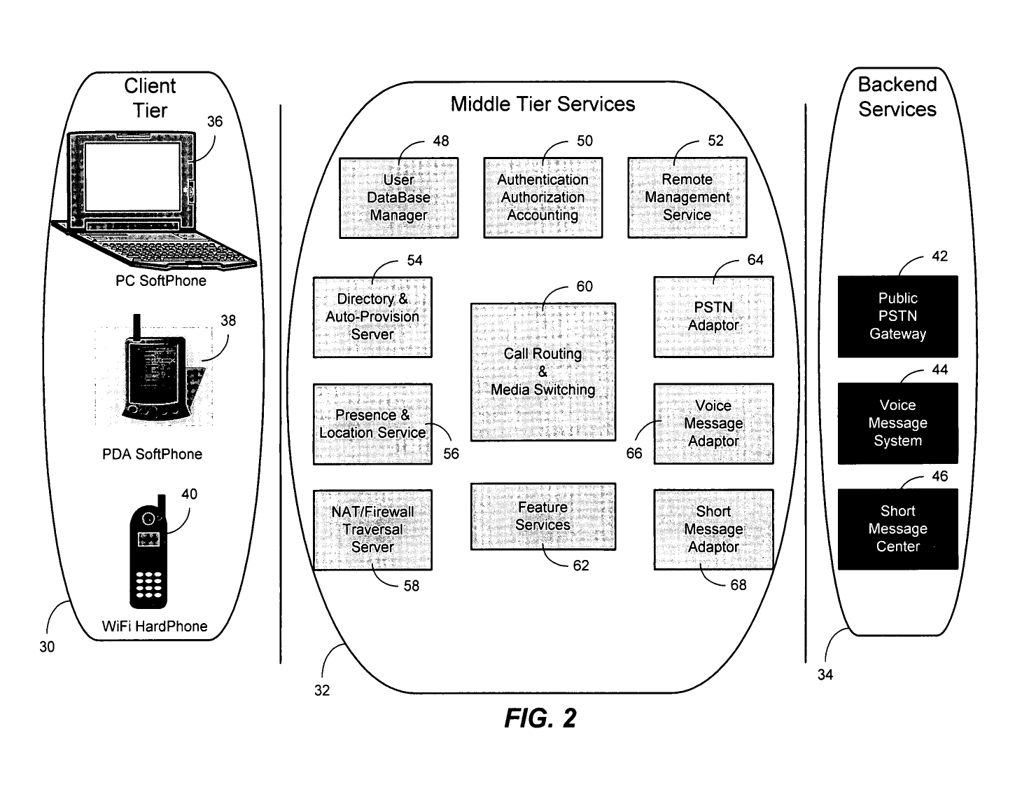

Together, the base stations 18 and the core switches 14 form an application-level network to service the VoIP terminals 20 thereby providing the critical middle-tier services depicted in FIG. 2, which will be described in further detail below. The communication paths among the base stations 18 and core switches 14 can be any Internet connection, but can also be specially provisioned transmission links. Specially provisioned transmission links are particularly useful to provide adequate bandwidth between traffic hotspots.

Generically, the overlay network 10 provides two classes of transport services: ‘Media streaming’ and ‘messaging’, however, the overlay network 10 can be employed to provide other types of VoIP services. Typical VoIP services (e.g. voice call, voice mail access, video-on-demand) require ‘media streaming transport’. Typical text/data communication services (e.g. instant messaging, electronic mail, short message service) require the ‘messaging transport’. All high-level services delivered by the overlay network 10 rely on one or both of the basic transport services. Under the overlay network 10, all VoIP users and all backend services are identified by Session Initiation Protocol (SIP) Universal Resource Locators (URLs). Thus, calling a VoIP user or accessing a backend service are both equivalent to accessing a SIP URL using one or both of the basic transport services.

In operation, to communicate with other VoIP terminals 20 or to access any backend services on the managed overlay network 10, a VoIP terminal 20 must first select a ‘portal base station’ and latch onto it. The selection of the ‘portal base station’ is dependent on the network location of the VoIP terminal 20. Thus, the VoIP terminal 20 must go through the portal selection process every time its Internet Protocol (IP) address changes or when it roams from one subnet to another subnet. Subnets are a portion of a network that shares a network address with other portions of the network and are distinguished by a subnet number. An example would be a corporate network which may contain one or more subnets. Note that when a VoIP terminal 20 moves from one subnet having network address translation to another subnet also having network address translation, its IP address may be the same. Thus, the VoIP terminal must not rely only on its IP address change to initiate the portal selection procedure.

The method for selecting a portal is based on the standard SIP REGISTER method, which is disclosed in the reference, IETF RFC 3261, entitled “SIP: Session Initiation Protocol”, the contents of which are incorporated herein as though set forth in full. Besides portal selection, this method also provides ‘presence, location’, and ‘keep-alive’ services, which are discussed in further detail with reference to FIG. 2. Such services are critical for the VoIP terminal to maintain connection with the overlay network 10 on a continuous basis.

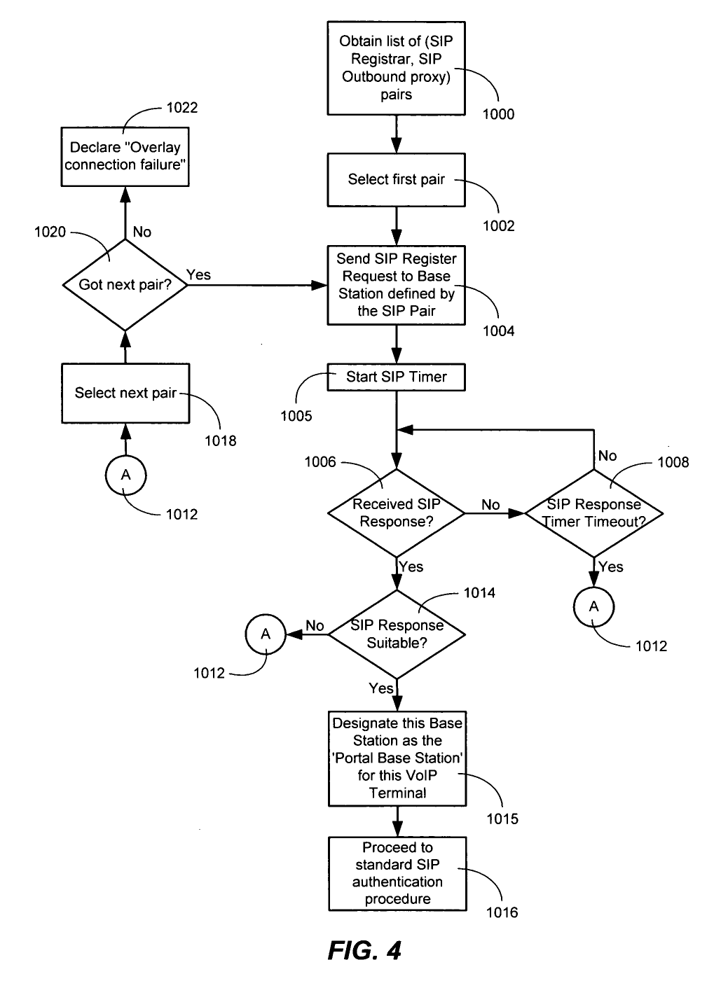

Each VoIP terminal 20 is first configured with a list of (SIP Registrar, Outbound SIP Proxy) pairs. The list can be obtained by user input, by Domain Name Service (DNS) or by other external means. To select a portal, the VoIP terminal ascends the list and verifies whether it can register successfully to the particular SIP Registrar. If successful, then it will use the particular pair of SIP Registrar and Outbound SIP Proxy as its SIP configuration and performs any standard SIP operations accordingly. If not successful, then it will check the next pair on the list. If the VoIP terminal exhausts the list without being able to find a suitable portal, then the VoIP terminal declares an “overlay connection failure” to the VoIP user. The method by which a VoIP terminal 20 determines whether or not a particular SIP Registrar is suitable is discussed later with reference to FIG. 4.

There are numerous specific advantages of the overlay architecture of the overlay network 10 of FIG. 1. One advantage is that it transforms the unmanaged peer-to-peer VoIP model to a managed service model. Thus, carriers can deliver services to end-users in a managed and accountable manner. End-users can also enjoy reliable services from the trusted carriers instead of rolling their own services.

Second, the overlay architecture allows the addition of adaptors which can connect to backend services such as PSTN calling, voicemail and Short Message Service (SMS) messaging thus providing a path to those services for VoIP terminals 20 while at the same time hiding the complexity of the overlay network 10 and VoIP terminals 20 from the backend services. The modular nature of this solution allows these services to be added incrementally and with no or minimal changes to the backend service.

Third, the presence and locations services provided by the overlay architecture allow mobile VoIP terminals 20 to move from one place to another and still be reachable with the same telephone number or address. The auto-provisioning service allows automatic update of configuration and parameters of a VoIP terminal 20. The service backbone can be overlaid on the Internet, and thus provides global coverage as offered by the Internet. This is especially important for supporting globally mobile VoIP terminals. Additionally, through the coordination capabilities of the base stations 18 and core switches 14 of the overlay architecture, VoIP terminals can still have access to the same services regardless of their location.

Fourth, the architecture allows for incremental deployment, where the overlay network 10 can start with a minimal one-node overlay network and expand the network as customer base and traffic increases.

Fifth, the TOI is based on existing standard protocols, thus, the architecture can support VoIP terminals 20 built by multiple vendors.

Sixth, in accordance with the architecture of the overlay network 10, all VoIP terminals 20 must join the overlay network 10 via well-defined entry points (i.e., the base stations 18). The overlay architecture provides directory and database services that enable authentication, authorization and accounting functions thereby creating a managed service for VoIP terminals 20 attempting to join the overlay network 10. Additionally, both intentional and unintentional intrusions in the overlay network 10 can be detected, prevented and logged. Finally, both call control messages and media streams flow through those entry points. Thus, the architecture can inherently support audio tapping. On the contrary, audio tapping is virtually impossible under the peer-to-peer model.

Seventh, since the architecture manages both call and media routing, it is capable of performing policy-based and Quality of Service (QoS) routing. Again, this is impossible under the peer-to-peer model over the existing Internet.

From the perspective of interfacing the PSTN network, the overlay architecture forms a critical middle-tier service between the VoIP terminals 20 and carrier-offered backend services. FIG. 2 depicts the multi-tier service architecture of the overlay network 10 of FIG. 1. In FIG. 2, a client tier 30, a middle tier services 32 and a backend services 34 is shown in accordance with an embodiment of the present invention.

As example of the component(s) of the client tier 30 are shown a PC softphone 36, a personal data access (PDA softphone 38 and a WiFi hardphone 40. The client tier 30 represents examples of the numerous and diverse VoIP terminals 20 of FIG. 1.

The backend services 34 is shown to include a public PSTN gateway 42, a voice message system 44 and a short message center 46, as examples of the services and structures and systems provide by the backend services 42. The backend services 42 represents the array of services provided by the carrier or value-added service providers 22 of FIG. 1. For example, PSTN calling, short messaging, voice mail and audio conferencing are offered as services. When the VoIP terminals 20 attempt to access the backend services 34 directly via the global Internet 12 of FIG. 1, many problems exist due to (a) the complexity of the Internet, (b) the diversity of the VoIP terminals 20, and (c) the intricacy of the backend infrastructure. The overlay architecture's middle-tier services 32 are designed to cope with all these problems, and to allow the carriers to offer enhanced services that are beyond the capabilities of their current backend infrastructure. The overlay architecture is a distributed design to implement the all-so-important middle-tier services.

The middle tier services 32 is shown to include a user database manager module 48, an authentication authorization accounting module 50, a remote management service module 52, a directory and auto-provision server 54, a presence and location service 56, a Network Access Translation (NAT)/Firewall traversal server 58, a call routing and media switching module 60, a feature services module 62, a PSTN adaptor 64, a voice message adaptor 66 and a short message adaptor 68.

In FIG. 2, the middle tier services 32, while not shown, communicates with the client tier 30 and to the backend services 34 and, in accordance with an embodiment of the present invention, includes the modules and other services or structures enumerated hereinabove.

The user database manager module 48 of the middle tier services 32 manages all of the user's database. Each user generally has associated therewith an identification number or value, in accordance therewith, the manager module 48 keeps information as to which services each user is entitled to and other types of information on the users. The module 50 is for authenticating and authorizing a user by verifying the user's identification information and the module 52 keeps a profile on the VoIP endport.

In essence, the middle tier services 32 of FIG. 2 allows for a device that is connected to it, such as anyone or all of the devices of the client tier 30, 36-40, to roam or be located in different places by routing these devices through different base stations by providing the address of the base station to which the device is to connect therethrough.

The feature services module 62 is for effecting phone service features, such as call forwarding, call waiting and the like. The call routing and media switching module 60 causes routing and switching to different base stations and routers within the overlay network 10 of FIG. 1. The module 58 is used to share a few public addresses by many private addresses. The module 56 is an instant messaging module that also locates the device within the network by knowing the Internet Protocol address of the device through which the user is communicating within the network. The module 68 allows short messaging to take place and to help route the same. The module 66 allows for voice messaging to take place and the module 64 is for effectuating communication with the public switching telephone network (PSTN). The module 68 communicates with the short message center 46 of the backend services 34, which is generally offered by carriers, such as AT&T. Similarly, the module 66 communicates with the voice message system 44 of the backend services 34 and the module 64 communicates with the public PSTN gateway 42 of the backend services 34.

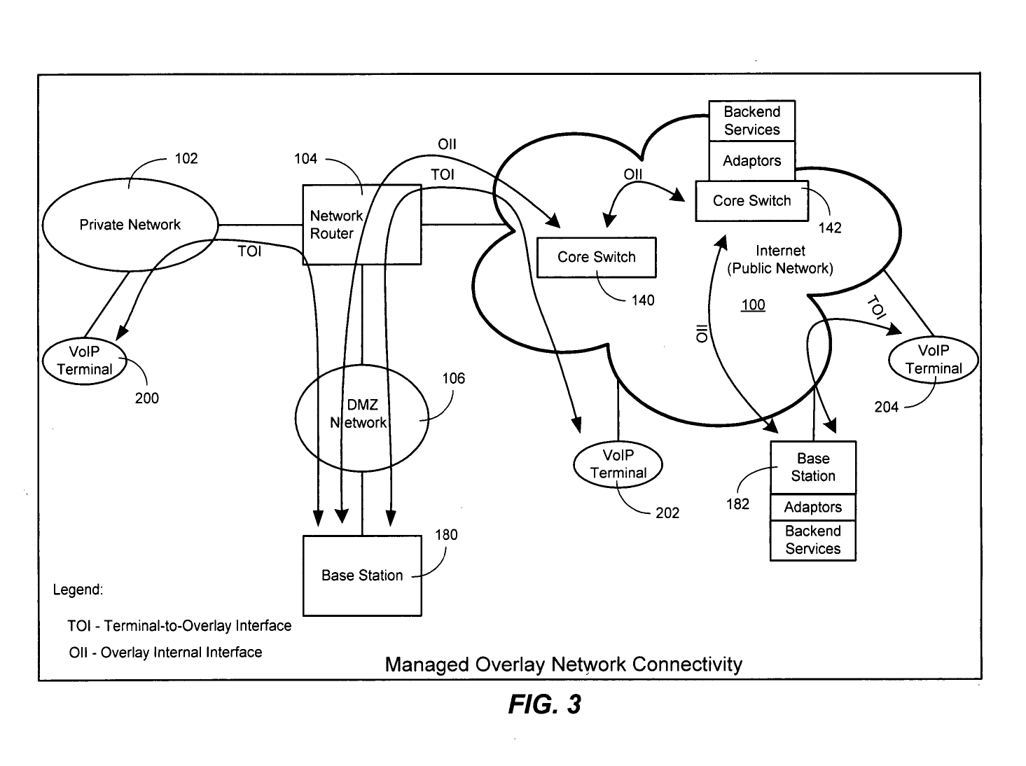

FIG. 3 shows a high-level and conceptual diagram of the connectivity of the overlay network 10 of FIG. 1 in accordance with an example embodiment of the present invention.

As shown in FIG. 3, the Internet 100 includes core switches 140 and 142 connected to each other and to the base station 182. The base station 182 is, in turn, shown connected to the VoIP terminal 204. The VoIP terminal 202 is shown connected to the Internet 100 and through the de-militarized zone (DMZ) network 106 to the base station 180. The DMZ network 106 is an area generally used by corporate networks for services that need to access both private networks as well as public network, such as the Internet, an example of which is mail servers where they are somewhat but not entirely protected. The Internet 100 is shown connected to the network router 104, which is shown connected to the private network 102, which is, in turn, connected to the VoIP terminal 200. The base station 180 is shown connected to the VoIP terminal 200, through the DMZ network 106, using TOI. Similarly, the base station 180 is shown connected to the VoIP terminal 202, through the DMZ network 106, using TOI. The Base station 180 is shown connected to the core switch 140 through the network router 104 and the DMZ network 106 using overlay internal interface (OII). The core switch 140 is shown connected to the core switch 142 using OII and the base station 182 is shown connected to the VoIP terminal 204 using TOI. The base station 182 is shown to include backend services, such as the backend services 34 of FIG. 2. Similarly, the core switch 142 is shown to include a backend services such as the backend services 34 of FIG. 2. PC, wireless equipment, PDAs or 802.11 modems and other similar equipment may use the embodiments of FIGS. 1-3.

FIG. 4 shows a flow chart of the steps performed when one of the VoIP terminals 20 of FIG. 1 selects a portal base station, as mentioned hereinabove. Essentially, these steps provide an example of the process that a VoIP terminal performs for selecting a base station through which the VoIP will be establishing a connection to the overlay network 10 of FIG. 1. It should be noted that the base station selected may be changed to another base station at a later point in time when and if the VoIP terminal roams or is located in an area different that where it was located when initially establishing a connection and if there is a reason for doing so due to the presence of a weak signal.

In accordance with the steps of FIG. 4, the VoIP terminal will choose a base station and if the signal thereto is strong enough, communication will start through the Internet and will continue, however, if the signal is weak, another base station is selected and the same process continues. If there are no strong signals detected to any of the base stations, the VoIP will drop out. There are various responses, received by the VoIP terminal, that are in accordance with standards set in the industry and that VoIP terminal understands and makes a determination accordingly. Some of these responses are discussed below.

At step 1000, a list of (SIP registrar, SIP outbound proxy) pairs is obtained. Next, at step 1002, a first pair is selected, thereafter, at step 1004, a SIP register request is sent to a selected address, namely, the address of a SIP registrar located in a base station 18 and a SIP timer is started at step 1005, after step 1004. Next, at 1006, a decision is made as to whether or not a SIP response has been received. If so, the process continues to step 1014 and if no response has been received, the process proceeds to 1008 at which time, it is determined whether or not the SIP response timer has timed out and if so, the process continues to step 1012, otherwise, the process resumes at 1006.

If at 1006, it is decided that a SIP response is received, next, a determination is made as to whether or not the SIP response is suitable at 1014 and if not, the process resumes at step 1012, otherwise, the next step is step 1015 where the base station contacted is designated (remembered by the VoIP terminal) as the current portal base station for the VoIP terminal. Finally, the process proceeds to a standard SIP authentication procedure, at step 1016.

At step 1012, the process simply proceeds to the next step, at step 101 8, selecting the next pair, next, at 1020, a determination is made as to whether or not the next pair is obtained and if so, the process resumes at step 1004, otherwise, the process goes to the step 1022 where a declaration is made as to an ‘overlay connection failure’.

To summarize, one of the VoIP terminal 20 of FIG. 1 sends a standard SIP Register request to the particular SIP Registrar. There are three possible outcomes at the VoIP terminal:
(i) receives an acceptable response such as “SIP 401 unauthorized” response from the SIP Registrar.
(ii) receives an unacceptable response such as “SIP 403 forbidden” response from the SIP Registrar.
(iii) receives no response from the SIP Registrar (based on the standard SIP timeout mechanism).
   The actions taken by the VoIP terminal for these cases are as follows:
(i) (Signifies this SIP Registrar is suitable) Remember the Portal Base Station associated with this SIP Registrar and proceed to use the standard SIP authentication procedure to authenticate against this SIP Registrar.
(ii) (Signifies this SIP Registrar is not suitable or not available or other error condition) Ascend the list and attempt to use the next SIP Registrar.
(iii) (Signifies this SIP Registrar is either out of service or its response is blocked by a firewall) Ascend the list to attempt to use the next SIP Registrar.
   Once a suitable SIP Registrar is found, the associated Outbound SIP Proxy will be used for all SIP communications.

The SIP Registration is preferably performed by the VoIP terminal 20, continuously at regular intervals signaling to the overlay network 10 that this VoIP terminal is alive and present. Furthermore, the network location contained in the SIP Registration request can also notify the overlay network 10 of any changes to the VoIP terminal's network address.

Accordingly, the present invention allows public carriers bring managed services to an infrastructure, such as the overlay network 10 of FIG. 1 thereby generating revenue and allowing for improved service to the user.

Recall that under the overlay architecture, a VoIP user and a service are both identified by a generic SIP URL. The SIP URL that identifies a VoIP user is called the ‘user address’ and the SIP URL that identifies a service is called the ‘service access point’. While structurally the same, there is a key difference between a ‘user address’ and a ‘service access point’. A ‘user address’ is unambiguously assigned by a central administrative authority. On the contrary, the ‘service access point’ is address-dependent on the user.

Under the overlay architecture, the method for making a call and accessing a backend service reduces to two fundamental steps. The first step includes the determination of the SIP URL of either the person calling, ‘user address’ or the ‘service access point’, and also the transport service to be used. This can be done by a local phone book, or a location-specific directory service, or a network-wide directory service. The second step includes accessing the appropriate transport service with the SIP URL, determined in the first step.

For accessing both ‘media streaming’ and ‘messaging’ transport types, the VoIP terminal can use the standardized SIP-based protocols. For ‘media streaming’ transport service, the VoIP terminal can use the standard SIP protocol. For ‘messaging’ transport service, the VoIP terminal can use the SIP extension for instant messaging protocol in accordance with the standard defined in a reference IETF RFC 3428, “Session Initiation Protocol (SIP) Extension for Instant Messaging”. Using this standardized and open approach, the overlay network 10 can support a wide range of VoIP terminals 20, built by different manufacturers per country and worldwide.

Message Transport and Media Streaming Service Primitives:

While the overlay architecture of the overlay network 10 offers two fundamental types of transport services to the VoIP terminals 20, the underlying Internet transport protocol used can be User Datagram (UDP), Transmission Control Protocol (TCP) or Transport Layer Security (TLS). Thus, the reliability and security of the two types of services may vary depending on which network protocol is used.

For Messaging, each message is packaged in a SIP Message format, and shipped from the VoIP terminal to its ‘portal’ using the SIP Message protocol. However, if UDP is used, the message may be subject to transmission errors and with no privacy. If TCP is used, transmission errors will not be an issue, but privacy is still lacking. If TLS is used, both transmission errors and privacy are non-issues. Once the message reaches the ‘portal’, the delivery of this message to the destination will be done according to the destination ‘user address’ or ‘service access point’. If the message is an instant message being sent to a VoIP terminal, the message may be delivered in a store-and-forward manner from the initial ‘portal’ to the destination ‘portal’ and eventually to the destination VoIP terminal. However, the delivery may not be real-time and may not even be guaranteed. If the message is an electronic mail being sent to a VoIP user, then the message may be delivered in a reliable manner to the destined VoIP user's electronic mailbox (which is actually a backend service).

For ‘media streaming’, the control/signaling is done via the SIP protocol. Once the ‘portal’ receives a media streaming request from a VoIP terminal, it will determine and establish a ‘signal route’ and a ‘media route’ to the destination specified in the SIP INVITE Request. The ‘signal route’ and the ‘media route’ are mostly independent. However, the first leg of both routes are always between the VoIP terminal and its ‘portal’. Thus, every call control and media streaming protocol data unit flows through the ‘portal’. Again, depending on the Internet transport protocol used, the reliability and security of this SIP call control/signaling can vary.

Message and Media Tapping:

For national security and law enforcement purposes, most countries require VoIP service providers to offer the capability of tapping into any conversation or message. The overlay network architecture has this inherent capability.

Since all control, message and media data flows through the Portal and all routing are done by the overlay network, the overlay architecture can perform tapping in multiple ways. One convenient way is to perform tapping at the Portal. Another way is to route the call being tapped to core switch 14 that is equipped with special tapping functions.

User Database and Overlay Management:

Under the overlay network architecture, user database and network management are done centrally at a Network Operation Center (NOC). All base stations 18 and core switches 14 of FIG. 1 can be remotely configured, monitored, and managed by the NOC. Both real-time and non-real-time management functions exist. For example, non-real-time user information, such as user ID, password, and preferences, are maintained centrally. Each node of the overlay network can access the central database information for such information. On the other hand real-time user information, such as presence and location information, is obtained by the ‘portal’ and reported to the central database, such as the one managed by the module 48.

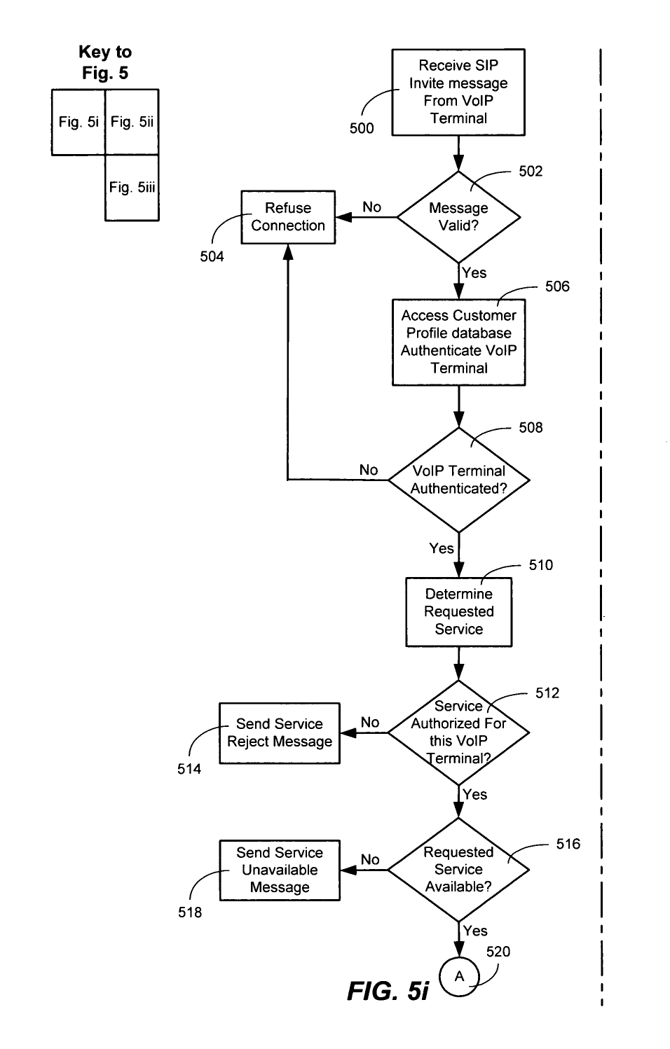

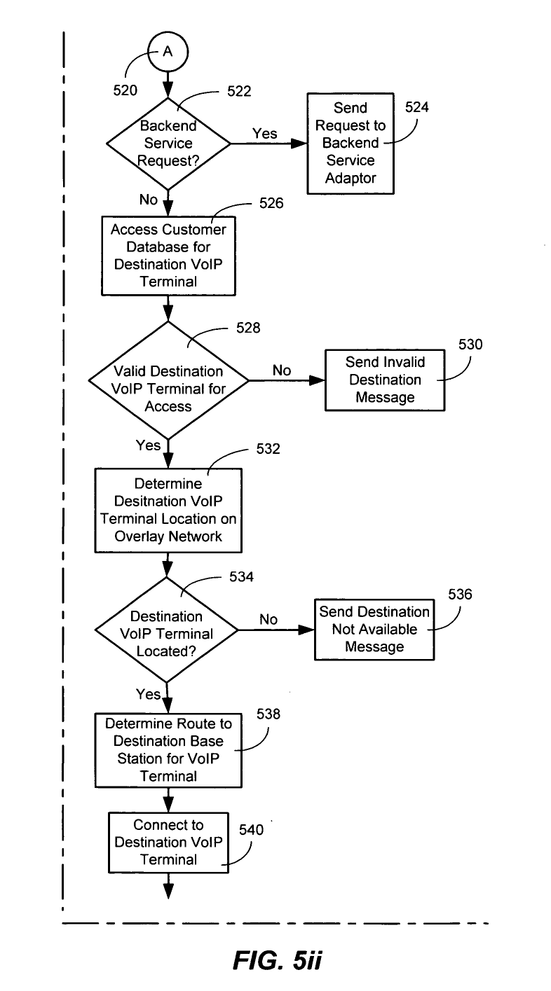

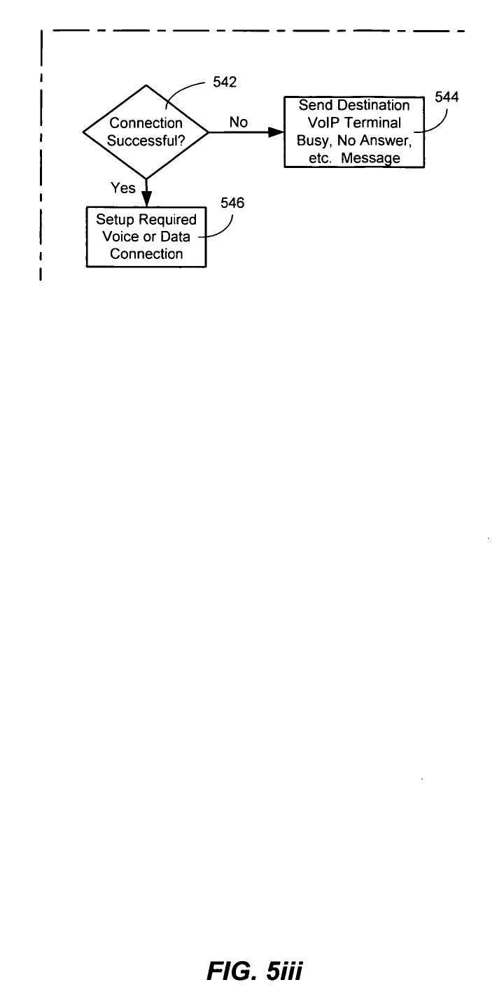

FIG. 5 shows a high level flow chart of the steps performed during a VoIP connection attempt. Initially, at step 500, an SIP invite message is received from a VoIP terminal, such as one of the terminals 20 of FIG. 1. Next, at step 502, it is determined whether or not the message is valid and if not, a connection is refused at step 504, otherwise, the process continues to step 506 where the customer profile database is accessed to authenticate the VoIP terminal. Next, at 508, it is determined whether or not the VoIP terminal is authenticated. If not, the process continues to step 504, otherwise, the process continues to step 510 at which time a requested service is determined. Next, at step 512, a determination is made as to whether or not the service is authorized for the authenticated VoIP of step 508 and if not, the process continues to step 514 where a service reject message is sent, otherwise, the process continues to step 516 where it is determined whether or not requested service is available. If not, a service unavailable message is sent at step 518 and if so, the process continues to 520 and onto the determination of 522.

At 522, it is determined whether or not there has been a request for a backend service and if so, a request is sent, at step 524, to the appropriate backend service adaptor 64-68 of FIG. 2. If, on the other hand, at 522, it is determined that no backend service request has been made, the next step 526 is executed where the customer database is accessed for a destination VoIP terminal. This is done by the user database manager 48 of FIG. 2.

Next, at 528, a determination is made as to whether or not a valid destination VoIP terminal has been accessed and if not, an invalid destination message is sent at step 530, otherwise, at step 532, a destination VoIP terminal is located on the overlay network 10 and the process continues to 534. At 534, it is determined whether or not the destination VoIP is located. If it is determined that the destination VoIP has not been located, a destination not available message is sent, otherwise, at step 538, a route to the portal base station 18 for the destination VoIP terminal is determined and next, at step 540, an attempt is made to connect the originating VoIP terminal to the destination VoIP terminal through the destination VoIP terminal's portal base station using the route determined in step 538.

Next, at 542, it is determined whether or not the connection of step 540 is successful and if not, a message indicative of the destination VoIP terminal being busy, not answering or the like is sent, otherwise, at step 546, a voice or data connection is setup.

Although the present invention has been described in terms of specific embodiment, it is anticipated that alterations and modifications thereof will no doubt become apparent to those more skilled in the art.. It is therefore intended that the following claims be interpreted as covering all such alterations and modification as fall within the true spirit and scope of the invention.

What is claimed is:

1. A managed mobile voice over internet protocol (VOIP) overlay network for use by public carriers for managing the connectivity and transport of media over the Internet comprising:
a distributed set of application service nodes deployed on top of the Internet and including a plurality of base stations; and
a plurality of VoIP terminals, located on the Internet, accessing the overlay network, one of the plurality of VoIP terminals latching onto one of the plurality of base stations, the selected base station onto which the VoIP terminal is latched being the ‘portal base station’, the latched VoIP terminal communicating only through the ‘portal base station’, to converse with another one of the plurality of VoIP terminals and for accessing backend services, the ‘portal base station’ being the sole entry point and communication proxy for the VoIP terminal 20 vis-à-vis the overlay network.

2. A managed mobile voice over internet protocol (VOIP) overlay network, as recited in claim 1, wherein the distributed set of application service nodes further includes a plurality of core switches.

3. A managed mobile voice over internet protocol (VOIP) overlay network, as recited in claim 1, further including a communication path between the latched VoIP terminal and the ‘portal base station’.

4. A managed mobile voice over internet protocol (VoIP) overlay network, as recited in claim 3, wherein the communication path is of a type of a group consisting of: a dial-up line, high-speed private network, virtual private link and an Internet connection..

5. A managed mobile voice over internet protocol (VOIP) overlay network, as recited in claim 1, further including sub networks wherein the plurality of base stations are deployed at the boundary between the sub networks and the Internet.

6. A managed mobile voice over internet protocol (VOIP) overlay network, as recited in claim 2, wherein the core switches are deployed within the core infrastructure of the public carrier.

7. A managed mobile voice over internet protocol (VoIP) overlay network, as recited in claim 1, further including Terminal-to-Overlay Interface (TOI) wherein the plurality of VoIP terminals connect to the Internet through the plurality of base stations over the TOI.

8. A managed mobile voice over internet protocol (VOIP) overlay network, as recited in claim 1, wherein provides different types of VoIP services. Typical VoIP services (e.g. voice call, voice mail access, video-on-demand) require ‘media streaming transport’..

9. A managed mobile voice over internet protocol (VOIP) overlay network, as recited in claim 1, wherein two classes of transport services are provided: ‘Media streaming’ and ‘messaging’.

10. A managed mobile voice over internet protocol (VOIP) overlay network, as recited in claim 1, further including a de-militarized zone (DMZ) network for connecting the plurality of VoIP terminals to the plurality of base stations.

11. A managed mobile voice over internet protocol (VOIP) overlay network, as recited in claim 2, further including a network router, at least one of the plurality of the base stations being coupled to at least one of the plurality of the core switches through the network router.

12. A managed mobile voice over internet protocol (VOIP) overlay network, as recited in claim 11, further including a DMZ network for coupling at least one of the plurality of the base stations to the at least one of the plurality of the core switches.

13. A managed mobile voice over internet protocol (VOIP) overlay network, as recited in claim 12, wherein the coupling through the DMZ network uses an overlay internal interface (OII).

14. A managed mobile voice over internet protocol (VOIP) overlay network, as recited in claim 13, wherein at least one of the base stations is coupled to at least one of the VoIP terminals using TOI.

15. A managed mobile voice over internet protocol (VOIP) overlay network, as recited in claim 14, further including a private network coupled to the network router and at least one of the plurality of VoIP terminals.

16. A method for establishing connection between a voice over internet protocol (VOIP) terminal and an overlay network comprising:
obtaining a list of SIP registrar pairs;
selecting a first pair from the obtained list of SIP pairs;
a VoIP terminal, about to establish a connection, sending a SIP register request to a selected address, the selected address being an address of a SIP registrar located in a base station defined by the selected first pair;
determining whether or not a timely SIP response to the sent request has been received;
upon determining that a timely response has been receiving, determining whether or not the SIP response is suitable;
upon determining that the received SIP response is suitable, designating the contacted base station as the current portal base station for the VoIP terminal.

17. A method for establishing connection, as recited in claim 16, further including starting a timer after the sending step.

18. A method for establishing connection, in an overlay network, by an originating VoIP terminal comprising:
receiving an SIP invite message a VoIP terminal;
determining whether or not the received message is valid;
if it is determined that the received message is not valid, refusing a connection otherwise;
accessing a customer database to locate a destination VoIP terminal;
locating a valid destination VoIP terminal on the overlay network;
determining a route to a portal base station for the destination VoIP terminal;
connecting the originating VoIP terminal to the destination VoIP terminal through the destination VoIP terminal's portal base station using the determined route; and
setting up a voice or data connection.

19. A method for establishing connection, as recited in claim 18, further including the step of authenticating the destination VoIP terminal using the customer.

20. A method for establishing connection, as recited in claim 18, further including the step of determining whether or not a valid destination VoIP terminal has been accessed.
